(19) United States
(12) Patent Application Publication
(10) Pub. No.: US 2002/0135476 A1
(43) Pub. Date: Sep. 26, 2002

(54) Sound and motion activated light controller

(76) Inventors: Edward C. McKinney JR., San Rafael, CA (US); Shek Fai Lau, Foster City, CA (US); Charles E. Taylor, Sebastopol, CA (US); Richard J. Thalheimer, San Francisco, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/816,286

(22) Filed: Mar. 21, 2001

Related U.S. Application Data
(60) Provisional application No. 60/265,234, filed on Jan. 31, 2001.

(51) Int. Cl. G08B 21/00

(52) U.S. Cl. 340/540; 340/565

(57) ABSTRACT

The present invention relates to a sound and motion activated controller adapted for turning on or off lights as either functional levers or an appliance controlled by the controller. The controller contains at least one motion sensor capable of detecting movement within a defined range and at least one sound sensor capable of detecting sound above a minimum threshold. The controller may also control the sensitivity of the motion sensor and the sound sensor. Further, the controller can adjust the intensity of the lighting within the room by use of a toggle control device located on the controller. Additionally, a mode control button allows a user to select whether the controller will operate in an automatic mode or a manual mode.

This application claims priority from provisional application “Sound and Motion Activated Light Controller”, Application No. 60/265,234, filed Jan. 31, 2001, and incorporated herein by reference.

### FIELD OF THE INVENTION

The present invention relates generally to sensors that have the ability to turn appliances on and off, such as for example lights. More specifically, the present invention is a sound and motion activated light controller whereby a light may be turned on by a person coming within a predetermined motion sensing range or by making a sound above a predetermined threshold.

### BACKGROUND

The operation of lights is often controlled by manually operated switches. These switches are provided for turning on and off light fixtures within the room that are plugged into electrical receptacles wired to the wall switch. A person entering a darkened room must search for the switch to turn on the light. When a person entering the room is carrying articles and does not have a free hand for searching for the switch, the person must enter the room and set down the articles in order to find the switch. Similarly, when a person is about to leave a room carrying a number of items, the person must either turn off the light before picking up the items before leaving the room, or must leave the room light on.

It is common practice for a person leaving the room to leave the light on even though the person may not intend to return to the room. Thus, the room lights are maintained on even when they are not needed. This practice results in waste of energy.

Thus, it would be desirable to have a controller for controlling the turning on and off of a room light automatically and instantly in response to a person entering a room and which also turns off the light sometime after the person exits the room. This would save energy because the light would be turned on only when needed and would be turned off a short time after the person has left the room.

### SUMMARY OF THE INVENTION

Accordingly, it is an object of the present invention to provide an improved controller adapted for operating a functional device which responds to variations in passive infrared radiation produced as the result of a movement of a source of infrared radiation within a given space.

It is another object of the present invention to provide a controller adapted for operating a functional device which responds to a sound emitted from a person or object above a certain threshold.

Yet another object of the present invention is to provide the user with the ability to adjust the sensitivity of the signal receiving device of the controller. Specifically, the user has the ability to choose how far from the controller a person must be and at what minimum threshold a sound must be to turn on lights connected to the controller. Additionally, while the lights connected to the controller are on, a user may adjust the intensity of the lights by selecting the appropriate controls on the controller.

### BRIEF DESCRIPTION OF DRAWINGS

FIG. 1 is a front view of the controller;

FIG. 2 is a side view of the controller;

FIG. 3 is a bottom view of the controller;

FIG. 4 is a front view of the faceplate of the controller;

FIG. 5 is a cut away perspective view of the controller;

FIG. 6 is a block diagram illustrating the functionality of the controller.

### DETAILED DESCRIPTION

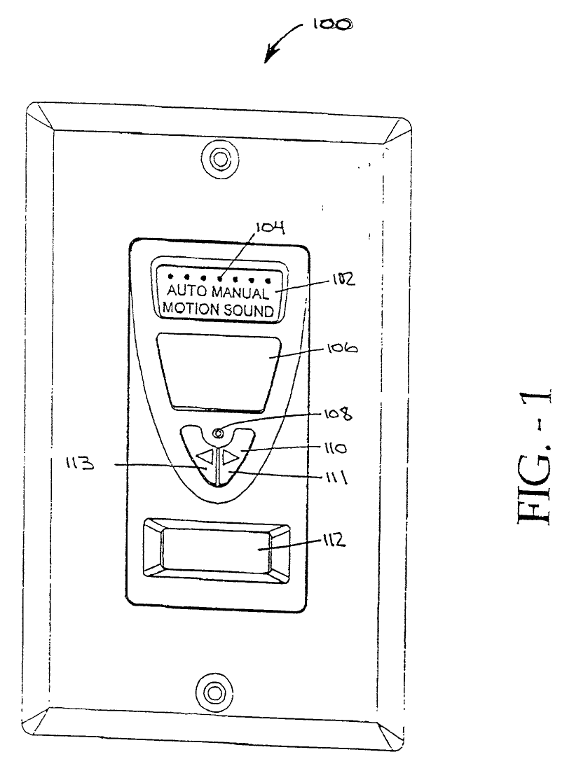

The controller 100 is designed to turn a light on automatically upon detecting an object within a detectable range or upon detecting a noise above a minimum threshold. Referring now to FIGS. 1-3, the controller 100 includes a mode control button 108, a display 102, a toggle switch 110, an on/off button 106 and a signal receiving device 112.

The controller 100 has four modes that it may operate from. The four modes are an automatic mode, a manual mode, a sound mode and a motion mode. The automatic mode and the manual mode determine when the controller 100 will turn on an appliance or functional device such as a light. The sound mode and motion mode allow the user to adjust the sensitivity of the microphone and the passive infrared (PIR) sensor to detect noise and heat capable of turning on the functional device.

At any time, a user may readjust the sensitivity of the microphone or the PIR sensor and change the operation from manual to automatic. Mode control button 108 allows a user to toggle through the four different modes of the controller 100. All four modes are displayed on display 102. By pressing the mode control button 108, a single mode will be highlighted. The highlighted mode is the mode the controller is currently performing.

The minimum threshold of noise or the distance a person (and thus strength of the infrared signal) must come within that will turn on a light will be specific to a user's needs and the surrounding area. The controller 100 does have predetermined settings for the sensitivity of the PIR sensor and the microphone. However, a user will likely prefer to adjust the sensitivity of the PIR sensor and the microphone to avoid the lights unnecessarily turning on.

In the motion mode, a user may adjust the sensitivity of the PIR sensor. The sensitivity of the PIR sensor is displayed by the number of indicia 104 that are lit in display 102. Toggle switch 110 allows the user to decrease or increase the sensitivity of the PIR sensor. By pressing the first end 111 of toggle switch 110, the sensitivity of the PIR sensor will increase. Similarly, by pressing the second end 113 of toggle switch 110, the sensitivity of the PIR sensor will decrease. From one to seven indicia 104 may be lighted, with one indicia 104 signifying the least sensitive setting of the PIR sensor and seven indicia 104 signifying the most sensitive setting of the PIR sensor. For example, when seven indicia 104 are lighted, the signal receiving device 112 will detect an object up to twenty feet from the controller 100. Thus, a person who comes within twenty feet of controller 100 will activate any lights that are connected to controller 100. Similarly, when only one indicia 104 is lit, an object must come within two feet of the controller 100 to automatically turn on a light.

A user may also adjust the sensitivity of the microphone located within the signal receiving device 112. In the sound mode, the sensitivity of the microphone is displayed by the number of indicia 104 that are lit in display 102. Toggle switch 110 allows the user to decrease or increase the sensitivity of the microphone from one to seven indicia 104 similar to the method described above concerning the PIR sensor. For example, when seven indicia 104 are lighted, the lowest threshold of sound that signal receiving device 112 can detect to activate a light connected to controller 100 is selected.

Upon setting the sensitivity of the PIR sensor and the microphone, the user should then press the mode control button 108 until the automatic or manual mode is highlighted in display 102.

When the controller 100 is in the automatic mode, the lights connected to the controller 100 automatically turn on when a sound or object is detected by the signal receiving device 112. For example, when a person enters the room and comes within the sensing range of the signal receiving device 112 or makes a sound above a predetermined threshold, all lights connected to controller 100 will turn on. Even though the automatic mode has been selected, the user can turn the lights on and off manually by pressing the on/off button 106. The controller 100 will reset itself to the automatic mode ten seconds after a user presses the on/off button 106 to turn off alight, thus enabling the controller 100 to detect signals. This ten second period allows a user to turn the light off when exiting a room, yet allows the controller 100 to automatically turn the light on again when a sound or object is subsequently detected by the signal receiving device 112.

The controller 100 may also operate as a typical light switch if the user so chooses. When the controller 100 is in the manual mode, the user must press the on/off button 106 to turn the lights on and off.

If the light connected to the controller 100 is an incandescent light, the intensity of the light can also be adjusted whether the controller 100 is in the automatic mode or the manual mode. When the light is turned on, the lighted indicia 104 in display 102 signify the intensity setting of the lights within the room. Pressing either the first end 111 or the second end 113 of the toggle switch 110 will increase or decrease the intensity of the light. The number of indicia 104 lighted in display 102 signifies the intensity setting of the light. Similar to the sensitivity settings for the microphone and the PIR sensor, one lighted indicia 104 signifies the lowest intensity setting of the light and seven indicia 104 signify the highest intensity setting of the light. Thus, the controller 100 also functions as a dimmer switch whereby a user may dim or brighten the light connected to the controller 100.

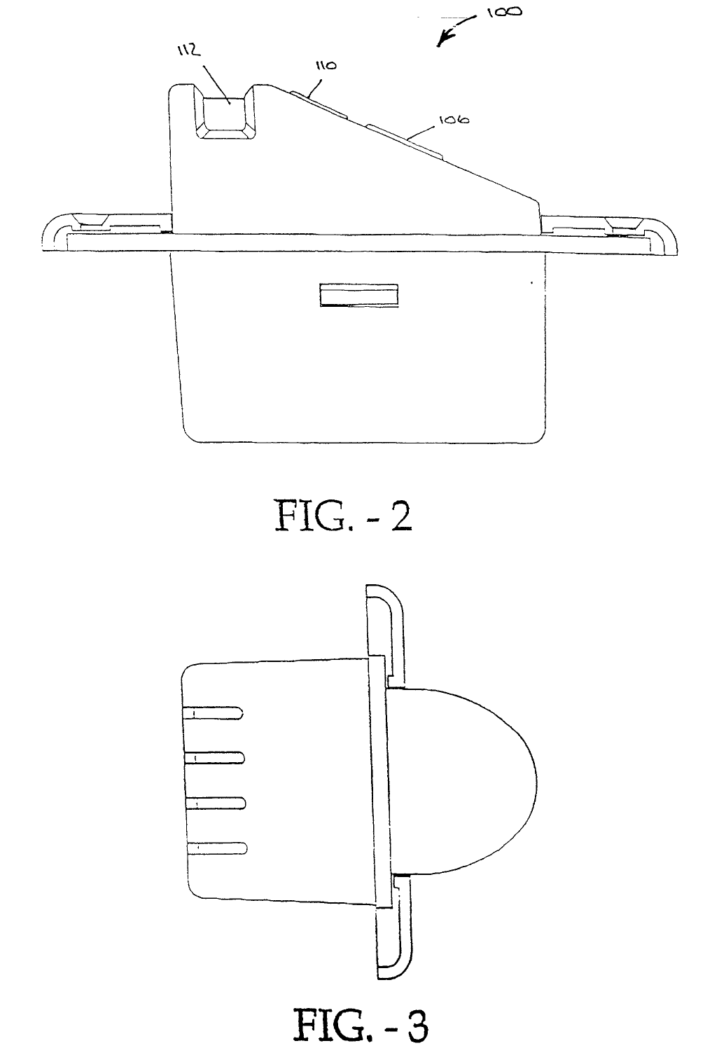

To conserve energy, the controller 100 also has a timer (embedded in the circuitry of FIG. 2) to limit the amount of time a light will remain on. When signal receiving device 112 detects an object or a noise capable of turning on the light connected to the controller 100, a timer is activated. The timer ensures that the light connected to the controller 100 remain on for at least five minutes beyond the last object or noise was detected by the signal receiving device 112. For example, when a person leaves a room, the light connected to the controller 100 will automatically turn off after five minutes if a person does not re-enter the room or make a noise capable of being detected by the signal receiving device 112.

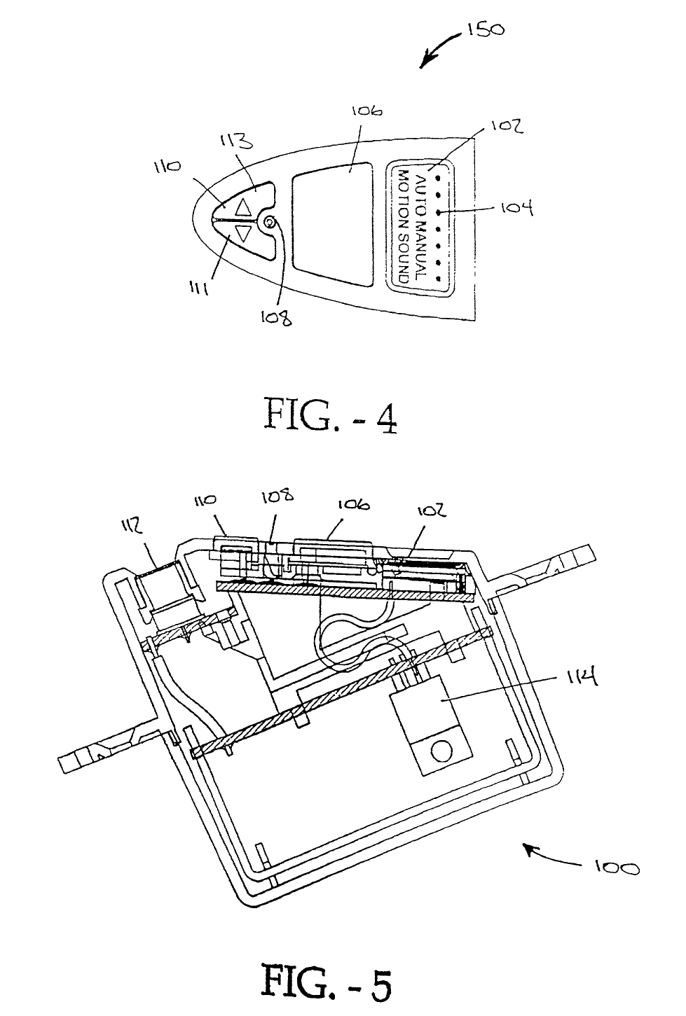

The controller 100 has a faceplate 150. Faceplate 150 is designed for easy access to the controls. Referring now to FIG. 4, faceplate 150 contains display 102, on/off button 106, mode control button 108 and toggle switch 110. Display 102 is located near the top of faceplate 150 of the controller 100. Display 102 displays indicia 104 across the top portion of display 102 and the modes which the controller 100 may operate from. On/off button 106 is located below display 102 allowing a user to manually turn on and off lights connected to the controller 100. The size and location of the on/off button 106 is such that a casual user does not mistake the signal receiving device 112 for the on/off button 106, thus preventing the user from touching and damaging the signal receiving device 112. Toggle switch 110 is located below the on/off button 106 and contains a first end 111 and a second end 113. The first end 111 of toggle switch 110 allows the user to increase the sensitivity of the microphone and the PIR sensor located within the signal receiving device 112 and the intensity of the light or lights connected to the controller 100. The second end 113 of toggle switch 110 allows a user to decrease the sensitivity of the microphone and PIR sensor located within the signal receiving device 112 and the intensity of the light or lights connected to the controller 100. The mode control button 108 is located between the on/off button 106 and the toggle switch 110. The size of mode control button 108 is such that the mode control button 108 may be located between the first end 111 and the second end 113 of toggle switch 110.

The placement of the controller circuit 114 within the controller 100 is shown in FIG. 5. The controller circuit is connected to the elements listed above on face plate 150 and the signal receiving device 112. The controller circuit 114 receives input from the settings in the motion and sound mode, and further from the signal receiving device 112 to determine when to turn on the light.

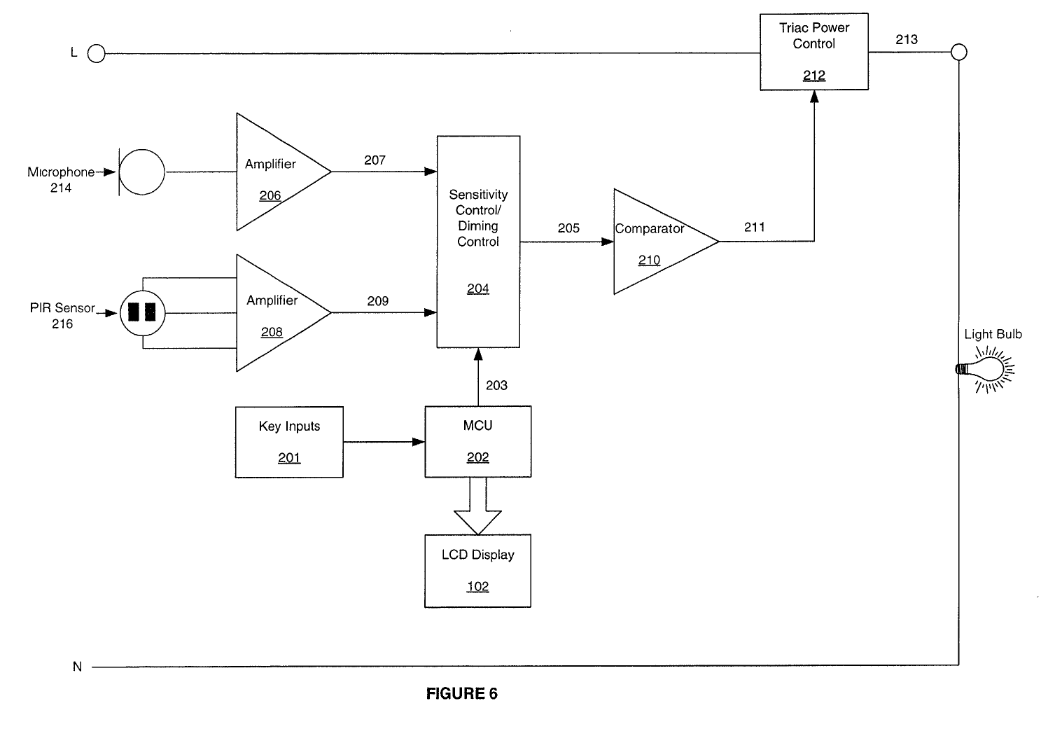

The steps performed by controller circuit 114 are shown by the block diagram in FIG. 6. When the controller 100 sends an “on” signal to alight, two signals are actually sent. Simultaneous with the signal to turn on the light, a signal defining the intensity of the light is also sent.

However, signals 207 and 209 may not be strong enough to turn on the light connected to the controller 100. Whether the signal from the microphone 214 or the PIR sensor 216 will turn on a light connected to the controller 100 depends on the specific sensitivity level set by the user. As described above, a user selects key inputs 201 (intensity levels of indicia 109) to determine what level of noise (sensitivity of the microphone 214) or how close an object must get to the controller 100 (sensitivity of the PIR sensor 216) to turn on a light. The key inputs 201 are stored in the micro control unit (MCU) 202. Even though the sensitivity of the microphone 214 and the PIR sensor 216 are adjustable, the microphone 214 and PIR sensor 216 are always active. When the microphone 214 detects a noise, the signal 207 sent by amplifier 206 is passed to the sensitivity/dimming control device 204. Similarly, when the PIR sensor 216 detects an object, the signal 209 sent by amplifier 208 is passed to the sensitivity/dimming control device 204.

The sensitivity/dimming control device 204 functions as an attenuator, setting the level of resistance that the signal 207 and 209 must overcome to generate signal 205 to the comparator 210. The sensitivity/dimming control device 204 is preprogrammed by the MCU 202. For example, when signal 207 or 209 is sent to the sensitivity/dimming control device 204, the signal 205 will not be passed to the comparator 210 unless the signal 207 or 209 is above the threshold set by the MCU 202. In that case, the noise or object detected by the microphone 214 or the PIR sensor 216 will not turn on a light.

The comparator 210 provides an internal reference voltage that functions as a threshold that signal 205 must overcome in order for the signal to pass to the triac power control 212. The comparator 210 functions as an AND gate array whereby the signal 205 is compared to the internal reference voltage. If the signal 205 passes to the triac power control 212, the signal 213 will turn on the light.

The dimming control function of the sensitivity/dimming control 204 can also control the intensity level of an incandescent light connected to the controller 100. The intensity level is preprogrammed by key inputs 201 (level of indicia 109) stored in the MCU 202. The sensitivity/dimming control 204 receives the intensity level from the MCU 202. The intensity level signal is passed from the sensitivity/dimming control 204, along with the signal 207 or 209 to form signal 205. The signal 205 will then be passed to the triac power control 212. Signal 213 is then sent to the light, thus controlling the power and intensity of the light.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A sound and motion activated controller adapted for operating a functional device, the controller comprising:
at least one motion sensor element capable of detecting movement;
at least one sound sensor element capable of detecting sound;
a controller circuit connected with the motion sensor element for providing an output adapted for operating a functional device in response to movement detected, and further connected with the sound sensor element for providing an output adapted for operating a functional device in response to a sound detected;
a mode control device for selecting a function of the light controller;
a toggle control device, whereby the user may adjust the sensitivity of the sound sensor element and the motion sensor element, and further for adjusting the intensity of the functional device; and
whereby the functional device can be activated by either the motion sensor element or the sound sensor element of the controller, and when the functional device is activated, the controller is adapted to ensure that the functional device remains activated for a period beyond the last sound or motion detected by the motion sensor element or the sound sensor element.

2. The sound and motion activated controller according to claim 1, whereby the motion sensor element is a passive infrared sensor.

3. The sound and motion activated controller according to claim 2, whereby the motion sensor element can be adjusted to determine what distance from the controller the motion sensor element will detect movement.

4. The sound and motion activated controller according to claim 3, whereby the motion sensor element may detect movement up to twenty feet from the controller.

5. The sound and motion activated controller according to claim 1, whereby the intensity of the functional device may be adjusted.

6. The sound and motion activated controller according to claim 1, whereby the sound sensor element may be adjusted to determine the threshold at which the sound sensor element will detect a sound and activate the functional device.

7. A sound and motion activated controller adapted to control a functional device, the controller comprising:
a mode control button allowing a user to select a mode of the controller;
a display for displaying the function the controller is performing;
a toggle switch for adjusting the selected mode of the controller, and further adapted for adjusting the intensity of a functional device;
an on/off button adapted for manually controlling the functional device;
a timer adapted to ensure that the functional device selectively remains activated for a period of time; and
a signal receiving device for receiving signals capable of being detected by a motion sensor and a sound sensor.

8. The sound and motion activated controller according to claim 7, whereby the mode control button allows a user to select an automatic mode, a manual mode, a sound mode and a motion mode.

9. The sound and motion activated controller according to claim 8, whereby when the automatic mode is selected and displayed on the display, a sound or movement detected by the signal receiving device activates the functional device.

10. The sound and motion activated controller according to claim 9, whereby the functional device may also be activated and deactivated by pressing the on/off button.

11. The sound and motion activated controller according to claim 8, whereby when the manual mode is selected and displayed on the display, the functional device can only be activated and deactivated by pressing the on/off button.

12. The sound and motion activated controller according to claim 8, whereby when the sound mode is selected and displayed on the display, the sensitivity of the signal receiving device to detect a sound can be adjusted by the toggle switch.

13. The sound and motion activated controller according to claim 8, whereby when the motion mode is selected and displayed on the display, the sensitivity of the signal receiving device to detect movement can be adjusted by the toggle switch.

14. The sound and motion activated controller according to claim 12, whereby the level of sensitivity of the signal receiving device is displayed on the display by the number of indicia lighted.

15. The sound and motion activated controller according to claim 14, whereby from one to seven indicia may be lit with one indicia signifying the least sensitive setting of the signal receiving device and seven indicia signifying the most sensitive setting of the signal receiving device.

16. The sound and motion activated controller according to claim 13, whereby the level of sensitivity of the signal receiving device is displayed on the display by the number of indicia lighted.

17. The sound and motion activated controller according to claim 16, whereby from one to seven indicia may be lit with one indicia signifying the least sensitive setting of the signal receiving device and seven indicia signifying the most sensitive setting of the signal receiving device.

18. The sound and motion activated controller according to claim 7, whereby when the automatic mode or manual mode is selected and the functional device is activated, the intensity of the functional device may be adjusted by using the toggle switch.

19. The sound and motion activated controller according to claim 18, whereby the intensity of the functional device is displayed on the display by the number of indicia lighted.

20. The sound and motion activated controller according to claim 19, whereby from one to seven indicia may be lit with one indicia signifying the lowest intensity setting of the functional device and seven indicia signifying the highest intensity setting of the functional device.

21. A sound and motion activated controller adapted to control a functional device, the controller comprising:
a display located near the top of a faceplate of the controller, displaying indicia and a plurality of modes which a user may select;
a signal receiving device located near the bottom of the faceplate of the controller;
an on/off button located below the display and adapted to allow a user to manually activate and deactivate a functional device connected with the controller;
a toggle switch located below the on/off switch with a first end and a second end, whereby the first end allows a user to increase the sensitivity of the signal receiving device and the second end allows a user to decrease the sensitivity of the signal receiving device; and
further adapted for adjusting the intensity of the functional device; and
a mode control button located between the on/off button and the toggle switch, whereby a user may select which mode is displayed on the display.

22. The sound and motion activated controller according to claim 21, whereby the mode control button allows the user to select an automatic mode, a manual mode, a sound mode and a motion mode.

23. The sound and motion activated controller according to claim 22, whereby when the automatic mode is selected and displayed on the display, a sound or movement detected by the signal receiving device activates the functional device.

24. The sound and motion activated controller according to claim 23, whereby the functional device may be activated and deactivated by pressing the on/off button.

25. The sound and motion activated controller according to claim 22, whereby when the manual mode is selected and displayed on the display, the functional device can only be activated and de activated by pressing the on/off button.

26. The sound and motion activated controller according to claim 22, whereby when the sound mode is selected and displayed on the display, the sensitivity of the signal receiving device to detect a sound can be adjusted by the toggle switch.

27. The sound and motion activated controller according to claim 22, whereby when the motion mode is selected and displayed on the display, the sensitivity of the signal receiving device to detect movement can be adjusted by the toggle switch.

28. The sound and motion activated controller according to claim 26, whereby the level of sensitivity of the signal receiving device is displayed across the top of the display by the number of indicia lighted.

29. The sound and motion activated controller according to claim 28, whereby from one to seven indicia may be lit with one indicia signifying the least sensitive setting of the signal receiving device and seven indicia signifying the most sensitive setting of the signal receiving device.

30. The sound and motion activated controller according to claim 27, whereby the level of sensitivity of the signal receiving device is displayed across the top of the display by the number of indicia lighted.

31. The sound and motion activated controller according to claim 30, whereby from one to seven indicia may be lit with one indicia signifying the least sensitive setting of the signal receiving device and seven indicia signifying the most sensitive setting of the signal receiving device.

32. The sound and motion activated controller according to claim 21, whereby when the automatic mode or manual mode is selected and the functional device is activated, the intensity of the functional device may be adjusted by using the toggle switch.

33. The sound and motion activated controller according to claim 32, whereby the intensity of the functional device is displayed across the top of the display by the number of indicia lighted.

34. The sound and motion activated controller according to claim 33, whereby from one to seven indicia may be lit with one indicia signifying the lowest intensity setting of the functional device and seven indicia signifying the highest intensity setting of the functional device.

35. The sound and motion activated controller according to claim 21, whereby the size and location of the on/off button is such that a casual user does not mistake the signal receiving device for the on/off button, thus preventing a user from touching and damaging the signal receiving device.

36. The sound and motion activated controller according to claim 21, whereby the size of the mode control button is such that the mode control button may be located between the first end and the second end of the toggle switch.

37. A sound and motion activated controller adapted to control a functional device, the controller comprising:
a display for displaying the mode the controller is performing;
a signal receiving device for receiving signals capable of being detected by a motion sensor and a sound sensor;
a toggle switch with a first end and a second end, whereby the first end allows a user to increase the sensitivity of the signal receiving device and the second end allows a user to decrease the sensitivity of the signal receiving device, and further adapted for adjusting the intensity of the functional device;
an on/off button, whereby the size and location of the on/off button is such that a casual user does not mistake the signal receiving device for the on/off button, thus preventing a user from touching and damaging the signal receiving device; and
a mode control button allowing a user to select a mode of the controller, whereby the size of the mode control button is such that the mode control button may be located between the first end and the second end of the toggle switch.

38. The sound and motion activated controller according to claim 37, whereby the mode control button allows the user to select an automatic mode, a manual mode, a sound mode and a motion mode.

39. The sound and motion activated controller according to claim 38, whereby when the automatic mode is selected and displayed on the display, a sound or movement detected by the signal receiving device activates the functional device.

40. The sound and motion activated controller according to claim 39, whereby the functional device may be activated and deactivated by pressing the on/off button.

41. The sound and motion activated controller according to claim 38, whereby when the manual mode is selected and displayed on the display, the functional device can only be activated and deactivated by pressing the on/off button.

42. The sound and motion activated controller according to claim 38, whereby when the sound mode is selected and displayed on the display, the sensitivity of the signal receiving device to detect a sound can be adjusted by the toggle switch.

43. The sound and motion activated controller according to claim 38, whereby when the motion mode is selected and displayed on the display, the sensitivity of the signal receiving device to detect movement can be adjusted by the toggle switch.

44. The sound and motion activated controller according to claim 42, whereby the level of sensitivity of the signal receiving device is displayed on the display by the number of indicia lighted.

45. The sound and motion activated controller according to claim 44, whereby from one to seven indicia may be lit with one indicia signifying the least sensitive setting of the signal receiving device and seven indicia signifying the most sensitive setting of the signal receiving device.

46. The sound and motion activated controller according to claim 43, whereby the level of sensitivity of the signal receiving device is displayed on the display by the number of indicia lighted.

47. The sound and motion activated controller according to claim 46, whereby from one to seven indicia may be lit with one indicia signifying the least sensitive setting of the signal receiving device and seven indicia signifying the most sensitive setting of the signal receiving device.

48. The sound and motion activated controller according to claim 37, whereby when the automatic mode or manual mode is selected and the functional device is activated, the intensity of the functional device may be adjusted by using the toggle switch.

49. The sound and motion activated controller according to claim 48, whereby the intensity setting of the functional device is displayed on the display by the number of indicia lighted.

50. The sound and motion activated controller according to claim 49, whereby from one to seven indicia may be lit with one indicia signifying the lowest intensity setting of the functional device and seven indicia signifying the highest intensity setting of the functional device.
